(19) United States
(12) Patent Application Publication
(10) Pub. No.: US 2001/0049701 A1
(43) Pub. Date: Dec. 6, 2001

(54) Internet web page background advertising system

(76) Inventors: Everett B. Howerton III, Roswell, GA (US); Chuck E. Gabbard, Southport, NC (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/754,475

(22) Filed: Jan. 4, 2001

Related U.S. Application Data
(63) Continuation of application No. 09/325,251, filed on Jun. 3, 1999, now abandoned.
Application No. 09/325,251 is a continuation-in-part of application No. 09/193,459, filed on Nov. 16, 1998, now Pat. No. 6,205,432.
(60) Provisional application No. 60/088,149, filed on Jun. 5, 1998.

(51) Int. Cl. G06F 15/00

(52) U.S. Cl. 707/513; 707/515

(57) ABSTRACT

A web page advertisement system is provided for generating web page coding with a reference to a background advertisement. In some embodiments, the background reference causes an advertisement image to be tiled, or watermarked, across an end user browser screen behind the text and other foreground elements of a web page since the background reference includes, in some embodiments, a background attribute of a hypertext markup language (HTML) body tag. In one embodiment, static web page coding is created with a background reference to a specific background advertisement, optionally stored remotely from the static web page coding, while in another embodiment the background reference is a reference to a background advertisement serving software program, also optionally stored remotely, which is configured to serve through a plurality of background advertisements. In other embodiments, the web page coding is created dynamically, such as through one or more Common Gateway Interface (CGI) scripts, for example, with the background reference being to a particular advertisement in some embodiments and to a background advertisement serving software program in other embodiments. In some embodiments, the background advertisement is assigned to the entire web page, while in other embodiments, only particular frames or portions of tables are assigned a background advertisement. In some embodiments, exposures of the background advertisements are tracked and used to generate bills since the exposures are provided in exchange for value, such as monetary consideration, for example.

### CROSS-REFERENCES TO RELATED APPLICATIONS

This application is a continuation of U.S. patent application Ser. No. 09/325,251, filed Jun. 3, 1999, which claimed the benefit of U.S. Provisional Application No. 60/088,149, filed Jun. 5, 1998, now expired, and which was a continuation-in-part of U.S. patent application Ser. No. 09/193,459, filed Nov. 16, 1998, allowed Jul. 12, 2000, all of which are incorporated herein by reference in their entirety.

### STATEMENT AS TO ANY INVENTION RIGHTS UNDER FEDERALLY SPONSORED RESEARCH

Not applicable.

### BACKGROUND OF THE INVENTION

The present invention relates generally to the field of advertising systems, and more particularly to the field of Internet advertising.

The worldwide network of computers connected through the Transmission Control Protocol/Internet Protocol (TCP/IP) communications standard, commonly known as the Internet, has seen explosive growth during the last several years. This growth has been fueled in part by the introduction and widespread use of so-called “web” browsers, which allow for simple graphical user interface (GUI) access to network servers, which support documents formatted as so-called web pages. The World Wide Web (WWW), or “web”, is a collection of servers on the Internet that utilize a Hypertext Transfer Protocol (HTTP), which is an application protocol that provides users access to files and information (which can be in different formats such as text, graphics, images, sound, video, etc.) using a Standard Generalized Markup Language (SGML), which is an information management standard for providing platform-independent and application-independent documents that retain formatting, indexing, and linking information. SGML provides a grammar-like mechanism for users to define the structure of their documents and the tags they will use to denote the structure in individual documents. The page description language known as Hypertext Markup Language (HTML) is an application of SGML. HTML provides basic document formatting of text and images and allows the developer to specify hyperlinks, or “links,” to other servers and files. Use of an HTML-compliant client, such as a web browser, involves specification of an address via a Uniform Resource Locator (URL). Upon such specification, the client makes a TCP/IP request to the server identified in the URL and ultimately receives a “web page” (namely, a document and any accompanying graphics formatted according to HTML coding) in return. A “website”, “web site”, or “site” is a collection of web pages, typically hyperlinked together and accessible through a front or “home” page, which is often accessed when a URL without directory or file names is specified.

The recent growth of information applications on international public packet-switched computer networks, such as the Internet, suggests that public computer networks have the potential to establish a new kind of open marketplace for goods and services. As web pages, discussion forums and e-mail communications are used more nationally and internationally, it is highly desired that manufacturers and merchants be able to non-offensively advertise their goods and services to users during their regular course of Internet activity. With only limited success, such advertising has been done through the use of images as well as text transferred over the Internet. Advertisements transferred over the Internet often, but not always, make use of trademarks. A “trademark” is a word, design, color, sound, smell, etc., or any combination thereof, used by a manufacturer or merchant to identify their goods and/or services and distinguish them from others. In general, advertisements include most types of communications promoting goods and/or services of organizations or individuals, as well as promoting the organizations or individuals themselves. Entities owning or operating web pages with access to potential viewers of advertisements often charge a fee to other entities interested in advertising themselves and/or their goods and/or services.

On the Internet, as in more traditional venues of advertising, such as billboards, TV commercials, products, etc., most advertisements (ads) include promotional material intended to be used to interest consumers with particular goods or services. Currently, one primary way to advertise on the Internet is through ad banners, which often contain static or animated images, with or without trademarks, and normally (though not always) advantageously function as hyperlinks to advertisement owner web pages. Multiple entities wishing to advertise often pay owners of particular web pages to reference the banner ads of the entities, thus web page owners often utilize ad serving software programs to rotate or serve through multiple ads as users repetitively visit web pages. Banner advertisement brokers also exist for, in exchange for a fee or reciprocal banner advertisement placements, storing and serving through a plurality of banner advertisements. Such banner advertisements are typically referenced through a URL directed to an ad serving software program maintained by the banner advertisement brokerage, and the URL may include an identification of the web page owner to assist the ad serving software program.

Unfortunately, banner ads often disappear with scrolling by the user and take up precious screen space. Furthermore, because of typically large graphical content, banner advertisements are often slow in downloading. As a result, users often move down a web page or to another web page and do not wait for advertisements to complete the downloading process if text or other content is displayed before, or simultaneously with, the advertisements, thereby clearly diminishing the impact of the advertisements. If text or other content is displayed only after an advertisement is completely downloaded, users may become very frustrated with the owner of the advertisement if the wait time is prolonged. Interstitial displays, such as splash screens which appear in between web page requests and before a web page is actually delivered, also provide advertisement opportunities, but they are often extremely brief, thereby greatly lessening their effect.

Others have addressed the problem of getting advertisements to an end user through the use of screensavers, such as a product commercialized by PointCast, Inc., Sunnyvale, Calif., as described in U.S. Pat. No. 5,740,549 to Reilly, et al. Although the screensaver program approach does appear to be capable of communicating advertisements to some users, there are clearly disadvantages to displaying these advertisements in an area outside of the normal user work area during times of inactivity when a user may typically not be looking at the display. In addition, the extra steps required to install and update such software can be too complicated or cumbersome for some users. Advertisers also have used broadcast e-mails and public postings to send advertisement messages from themselves containing plain text, as well as HTML formatting for more effective display. In general, e-mail messages and public postings containing hyperlinks pointing to additional information are also known, such as described in U.S. Pat. No. 5,790,793. Unfortunately, users often immediately delete unsolicited e-mail messages, as well as those sent from unknown senders.

Outside the Internet, top of mind awareness (TOMA) advertising acquaints the public with advertisers' brand-names, logos, trademarks, etc., through selective infiltration and saturation in the market. The purpose of such advertising is not to compel immediate purchase, but to enhance public awareness of the availability of the product from a particular manufacturer or merchant, so that when shoppers are at the retail markets to make purchases, they will recognize brands and immediately have higher perceived values of those products in relation to like products by other manufacturers or merchants. The key to a TOMA campaign is repetition since the more times that an individual is exposed to a particular brand-name, logo, trademark, etc., the more likely that individual will buy a particular product when making a buying decision in the future. Unfortunately, on the Internet, TOMA advertising is rarely accomplished successfully since, as discussed above, most conventional Internet advertising methods often result in very limited exposure to users. This conclusion is evidenced by the attention brokerage system described in U.S. Pat. No. 5,794,210, which actually teaches a method of compensating users for paying attention to advertisements on the Internet.

There is, therefore, a need for an advertising system for addressing these and other needs and problems.

### BRIEF SUMMARY OF THE INVENTION

A web page advertisement system is provided for generating web page coding with a reference to a background advertisement. In some embodiments, the background reference causes an advertisement image to be tiled, or watermarked, across an end user browser screen behind the text and other foreground elements of a web page since the background reference includes, in some embodiments, a background attribute of a hypertext markup language (HTML) body tag. In one embodiment, static web page coding is created with a background reference to a specific background advertisement, optionally stored remotely from the static web page coding, while in another embodiment the background reference is a reference to a background advertisement serving software program, also optionally stored remotely, which is configured to serve through a plurality of background advertisements. In other embodiments, the web page coding is created dynamically, such as through one or more Common Gateway Interface (CGI) scripts, for example, with the background reference being to a particular advertisement in some embodiments and to a background advertisement serving software program in other embodiments. In some embodiments, the background advertisement is assigned to the entire web page, while in other embodiments, only particular frames or portions of tables are assigned a background advertisement. In some embodiments, exposures of the background advertisements are tracked and used to generate bills since the exposures are provided in exchange for value, such as monetary consideration, for example.

Since the advertisement is placed in the background when viewed by a user, it is normally non-clickable, i.e., not a hyperlink to another HTML page. While this novel system of advertising is unusual since a typical user may initially desire, as with conventional banner advertisement, to click on the background image to go to another web page owned by the advertiser for more information or for ordering a product, the user will often be exposed to the tiled advertisement longer, and many times subliminally, while reading the content of the message, and the user may also be initially surprised to see an advertisement in the background of a website not owned by the owner of the website, thus increasing the awareness and quality of exposure. Background images may also be very small in comparison to banner advertisements, thus downloading relatively quickly. In addition, web site owners are able to extract revenue for non-obtrusive advertising a larger percentage of the active screen while still providing a work area for users to perform desired functions. In addition, this display does not necessarily affect current advertisement banners being displayed. Other features and advantages of various preferred embodiments of the present invention will become apparent to one with skill in the art upon examination of the following drawings and detailed description.

### BRIEF DESCRIPTION OF THE SEVERAL VIEWS OF THE DRAWINGS

The accompanying drawings incorporated in and forming a part of the specification illustrate several aspects of the present invention, and together with the description, serve to explain the principles of the invention.

FIG. 1 is a block diagram illustrating physical components of one implementation of the present invention.

FIG. 2 is a block diagram illustrating one type of end user workstation in accordance with one preferred embodiment of the present invention.

FIG. 3 is a block diagram illustrating one type of network server in accordance with one preferred embodiment of the present invention.

FIG. 4 is a flowchart showing general system-level operation steps of the background reference system of the present invention, in accordance with one preferred embodiment.

FIG. 5 is an illustration of sample HTML web page coding with a background reference to a specific co-located advertisement file, in accordance with one implementation of the present invention.

FIG. 6 is an illustration of a web page corresponding to the HTML web page coding of FIG. 5.

FIG. 7 is an illustration of sample HTML web page coding with a background reference to an advertisement through an ad serving software program with a full path name, including identification information.

Reference will now be made in detail to the description of the invention as illustrated in the drawings. While the invention will be described in connection with these drawings, there is no intent to limit it to the embodiments disclosed therein. On the contrary, the intent is to cover all alternatives, modifications and equivalents included within the spirit and scope of the invention as defined herein and by the appended claims.

### DETAILED DESCRIPTION OF THE INVENTION

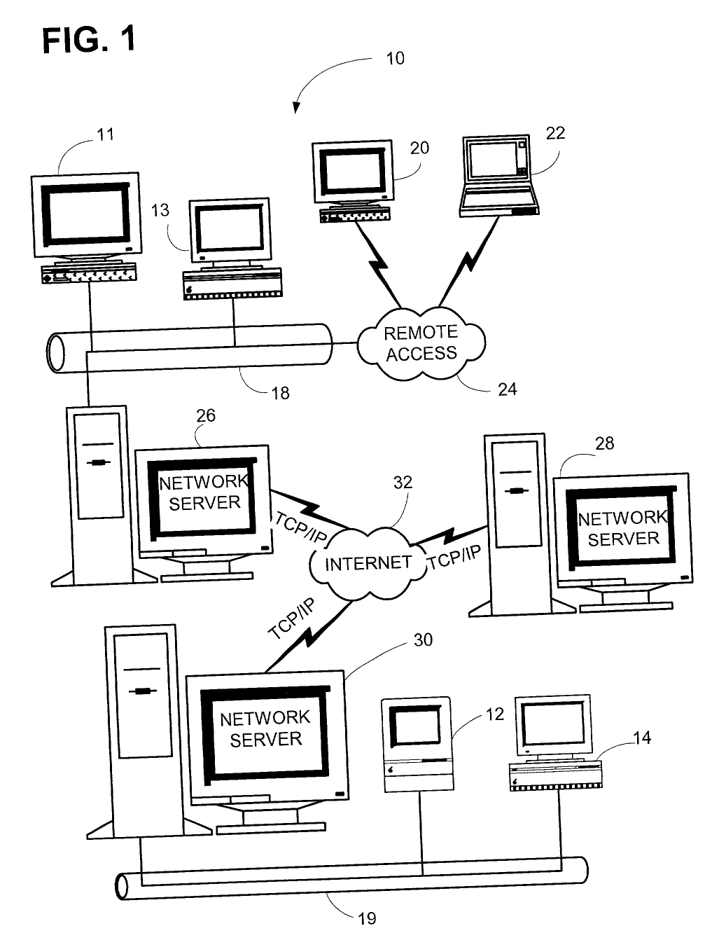

Turning now to the drawings, wherein like reference numerals designate corresponding parts throughout the drawings, FIG. 1 is a block diagram illustrating physical components 10 of one implementation of the present invention, which has flexibility, expandability, and platform independence. While system configuration can take many forms in accordance with scope of the present invention, the diagram of FIG. 1 illustrates a plurality of end user workstations 11, 12, 13 and 14 directly connected to networks 18 and 19, acceptable examples of which include, among others, local area networks (LANs) and Intranets. Additional workstations 20, 22 are remotely located and in communication with the network 18 through a remote access network 24. Network servers 26, 28, and 30, one or more of which are capable of functioning as a web server and/or an ad server to perform the background advertising methods in accordance with the present invention, as discussed below, are shown connected to each other through an Internet 32, with conventional routers and switches omitted for clarity, but understood by those reasonably skilled in the art of the present invention. Such network servers are configured to support one or more conventional communication protocols, including, but not limited to, HTTP, SMTP, POP3, IMAP, NNTP, etc. Of course, the elements of FIG. 1 are understood to be representative of multitudes of similarly connected components, and various types of conventional workstations are understood to be connected to the Internet 32 through conventional schemes.

In one application of the physical components 10, one organization owns and maintains the components directly connected to network 18, and another organization owns and maintains the components directly connected to network 19. For example, network server 26 can be maintained by an Online Service Provider (OSP) to provide OSP customers using workstations 20, 22 access to the Internet 32, including e-mail mailboxes and access to the web and public messaging. In another example, network 18 is maintained by a private company for purposes of providing employees access to the Internet. In some embodiments, network server 26 includes storage accessible from the Internet, and in other embodiments, network server 26 only provides access to the Internet for other components connected to network 18. As discussed below, in various embodiments, one or more network servers 26, 28, and 30 can be utilized to store web page coding, advertisements, and software for dynamically generating web page coding or managing and serving advertisements. Still other embodiments of the present invention include Intranet applications having no access to the Internet whereby an entity would pay a fee to an organization to background advertise to its employees only.

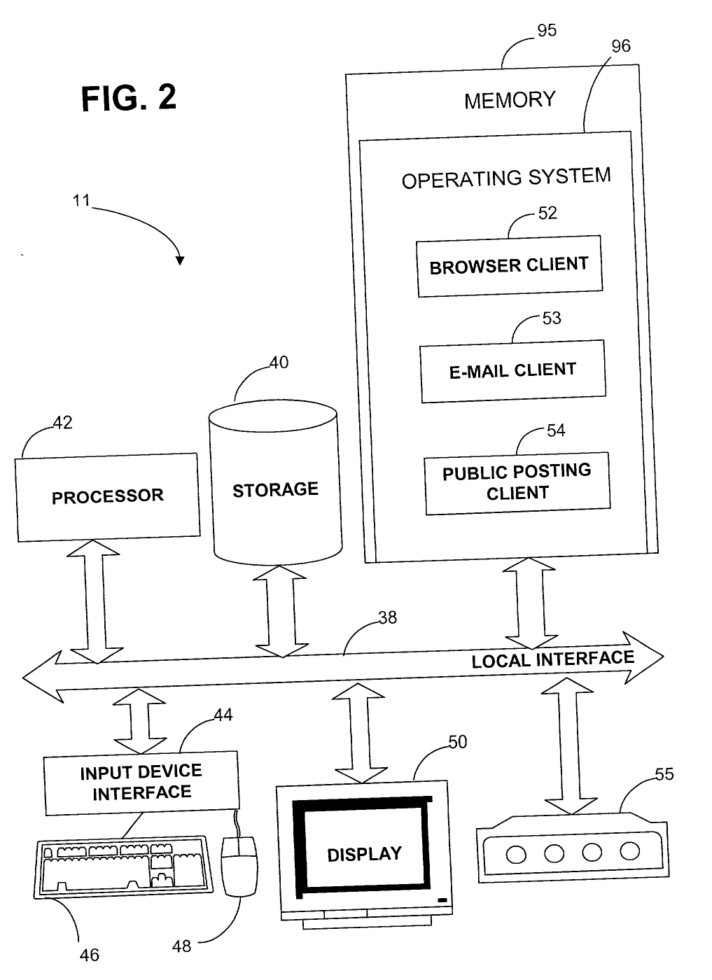

Refer now to FIG. 2, which is a block diagram illustrating one type of end user workstation 11, in accordance with one preferred embodiment of the present invention. A local interface 38, such as a conventional computer bus, is shown connected to a variety of components, including a storage unit 40, a processor 42, an input device interface 44 providing an interface to the local interface 38 for a conventional keyboard 46 and mouse 48, a display 50 for displaying information for being viewed by a user, a modem/network interface 55 for providing connectivity to other computers and networks, and memory 95. One example, among others, of an acceptable storage device 40 is a conventional hard drive, which is used for non-volatile storage of programs and other data which are loaded into memory 95 for operation of the workstation 11 and used by processor 42 to control operation of the workstation 11. Such programs (also referred to as applications, systems, software, etc.) typically include, among others, an operating system 96, a browser client 52, an e-mail client 53, and a public posting client 54. Examples of acceptable operating systems 96 include, among others, Microsoft® Windows® and Unix. Examples of acceptable browser clients 52 include, among others, Microsoft® Internet Explorer and Netscape Navigator. One example, among others, of an acceptable e-mail client is Eudora Pro Email v4.0. One example, among others, of an acceptable public posting client 54 is Microsoft® Outlook Express, which also functions as an acceptable e-mail client. Some web browser clients also function as non-web-based newsgroup and e-mail clients, thus also serving as enhanced readers of NNTP and POP3 information. Of course, the scope of the present invention is intended to include, but not be limited to, any client capable of displaying end user information with a definable background from any type of electronic feed, including but not limited to, web pages, e-mail messages, public postings, etc.

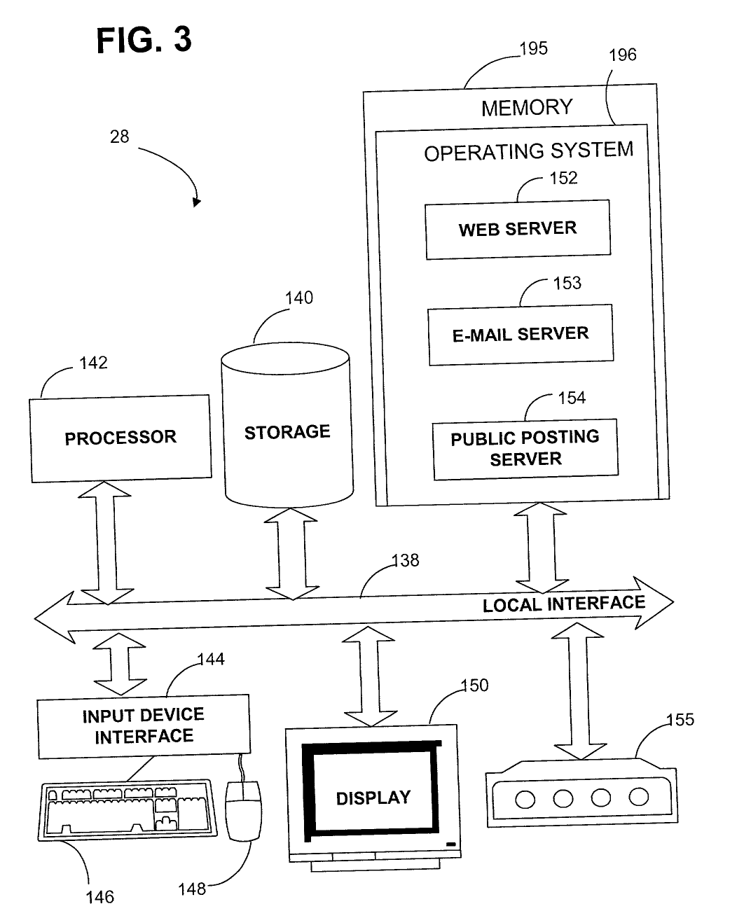

Refer now to FIG. 3, which shows a block diagram representation of selected elements of one type of network server 28, which is shown including hardware elements similar to those of the example workstation 11 shown in FIG. 2. For example, a local interface 138, such as a conventional computer bus, is shown connected to a variety of components, including a storage unit 140, a processor 142, an input device interface 144 providing an interface to the local interface 138 for a conventional keyboard 146 and mouse 148, a display 150, a modem/network interface 155 for providing connectivity to other computers and networks, and memory 195. One example, among others, of an acceptable storage device 140 is a conventional hard drive, which is used for non-volatile storage of software programs and other data which are loaded into memory 195 for operation of the network server 28 and used by processor 142 to control operation of the network server 28. However, the network server 28 executes software programs (also referred to as applications, systems, software, etc.) which are different from those of the workstations. For example, in accordance with one implementation, software executed by the network server 28 executes a web server 152 (for generation and utilization of web page coding), e-mail server 153, and public posting server 154, such as a newsgroup server.

Generally, web page coding is transmitted by web server 152 through local interface 138 and modem/network interface 155 to browser client 52 (FIG. 2). In one embodiment, static web page coding is stored in storage 140 for access and transmission by web server 152, and in other embodiments, web server 152 dynamically generates and transmits to browser client 52 (FIG. 2) web page coding as instructed by one or more software components. Acceptable types of such software components include one or more of the following, among others:

common gateway interface (CGI) scripts, including those written in C++, Pearl, etc., as well as server-side includes (SSIs), and active server pages (ASPs). In accordance with one embodiment, also stored in storage 140 are advertising files, including images, etc. In other embodiments, advertisements are stored in other remotely located network servers 26, 28, etc. As discussed below, in some embodiments, background references to specific advertisements are included and stored in static web page coding. In other embodiments, web serving software components dynamically insert background references to advertisements, which may be statically controlled through the web serving software components or selected from a plurality of available advertisements through integrated background advertisement serving components or through communication with separate background advertisement serving software programs.

In some embodiments, such separate background advertisement serving software programs are also part of web server 152, i.e., self-contained software components of web server 152, and in other embodiments, the separate background advertisement serving software programs are remotely located on different network servers 26, 28, etc. In accordance with some embodiments of the present invention, regardless of location or integration, the background advertisement serving software programs primarily respond to requests for advertisements by serving through a plurality of advertisements so that browser clients see different advertisements upon repeated viewings of a web page. In some embodiments, the background advertisement serving software programs also track advertisement exposures and provide for billing functionality. In addition, in some embodiments, such programs select advertisements according to identifications of particular web pages and/or web page owners, demographic information of users, etc. Such identification and demographic information can be included in a URL request, including through the specification of particular directories and subdirectories maintained by the background advertisement serving software programs. For example, if a user has requested a particular web page within a particular web site, certain demographic information is available for targeted background advertisements.

Functionality of the present invention can be implemented in hardware, software, firmware, or a combination thereof. In one preferred embodiment, functionality of the present invention is implemented in software or firmware that is stored in a memory and that is executed by a suitable instruction execution system. The present invention includes functionality which comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program or coding for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

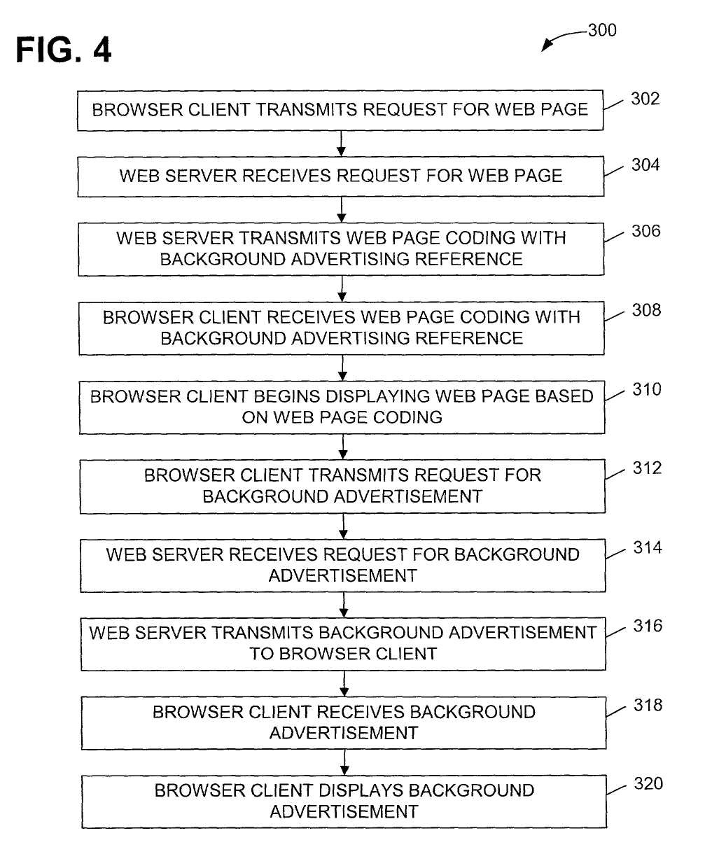

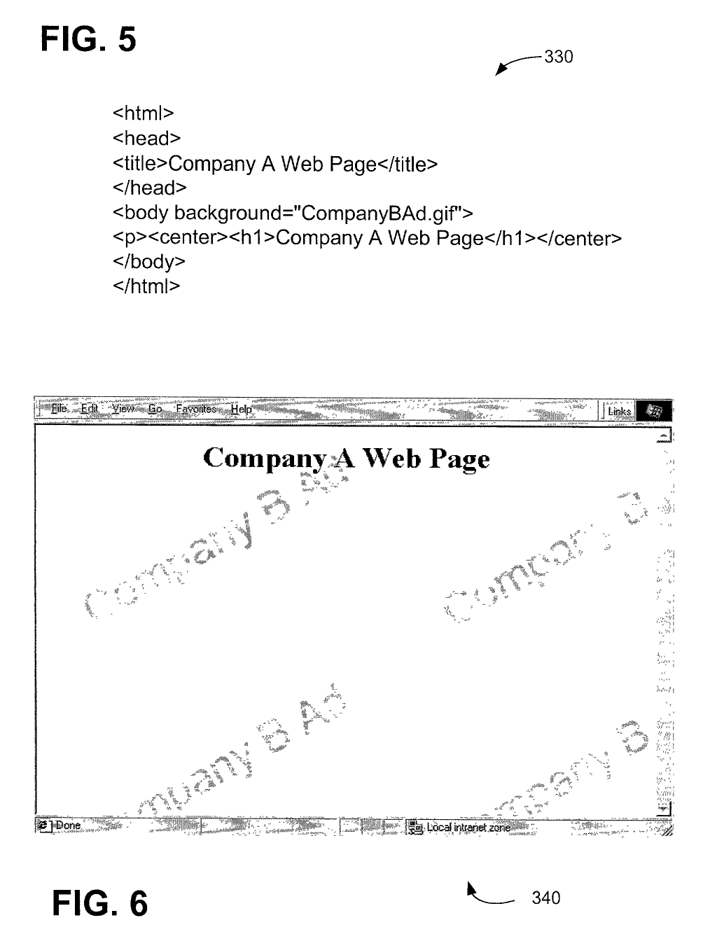

Refer also to FIG. 4, which is a flowchart showing general system-level operation steps 300 of the background reference system of the present invention, in accordance with one preferred embodiment. Initially, a browser client 52 (FIG. 2) transmits a request for a web page (step 302), which is often prompted by a user inputting a URL, or web page address, into the browser client 52, or by a user clicking on a link specifying the URL. As would be understood by those skilled in the art of the present invention, the URL is converted into an IP address and routed in manner whereby a request for a web page is eventually communicated to the web server 152 (FIG. 3) (step 304). Upon receiving the web page request, the web server 152 transmits (step 306) to the browser client web page coding that includes a background advertising reference. In one implementation, the background advertising reference is a background attribute of a hypertext markup language (HTML) body tag. Refer now to FIG. 5, which shows an illustration of sample HTML web page coding 330 with a background reference to a specific co-located advertisement file, in accordance with one implementation of the present invention. In that example, the body tag is shown as follows: <body background=“CompanyBAd.gif”>. In that example, the background attribute is set to an advertisement bitmap file named “CompanyBAd.gif” that is co-located with the web page coding or available in the directory referenced by the original URL since a complete pathname is not included. As discussed below, a corresponding example web page illustration 340 is shown in FIG. 6, with the CompanyBAd.gif file being represented as a more lightly shaded or colored diagonal “Company B Ad” tiled in background across an entire browser client window (tables, frames, etc. can also be used in other implementations to define areas for background image setting). Of course, many types of corporate trademarks, logos, animations, etc. can be stored as an advertisement, and it would be important in some implementations to lightly shade or color the advertisement to reduce visual interference with the foreground elements, such as basic text. The text characters “Company A Web Page” are shown as foreground elements. The title designated in the web page coding 330 is not shown in FIG. 6 but would appear at the top of the drawing.

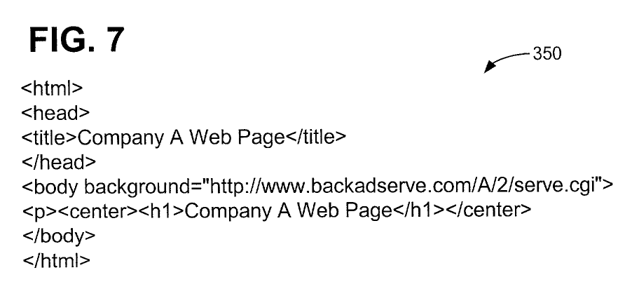

In a static web page coding implementation, a web page designer would have generated and stored the static web page coding with an inserted background advertising reference prior to step 306 in FIG. 4. In a dynamic web page coding implementation, step 306 includes executing web server software components, as discussed above, to generate and output web page coding, including inserting a background advertising reference. In addition, other web server software components or other co-located or remotely located software programs may, in accordance with various embodiments, be consulted to insert the proper background advertising reference. Furthermore, as discussed above, in some implementations the background advertising reference refers to a particular advertisement file, and in other implementations, the background advertising reference generically refers to background advertisement serving software programming, such as is referenced in web page coding 350 shown in FIG. 7. Referring now to FIG. 7, the background attribute of the body tag is set to the following hypothetical example: “http://www.backadserve.com/A/2/serve.cgi”. In this example, a CGI script entitled “serve.cgi” is located in the “/A/2” directory at the “backadserve.com” domain, with “A” identifying a web page owner and “2” identifying a particular web page of that web page owner. Thus, different ad serving software programs can be accessed based on which particular web page is being viewed for each particular web page owner. In other words, in this hypothetical example, the letter “A” is used as an example to identify a particular entity, but the identification could just as easily be the actual name of the entity or any other designation identifying the entity. Likewise, the number “2” is used as an example of an identifier for a particular web page, but other characters or directory names could be used to identify a particular web page. In addition, of course, directory names may also be used for other purposes related to other types of identification, as well as purposes completely unrelated to identification. Furthermore, in one implementation, a background advertisement brokerage, an example owner of the hypothetical domain name backadserve.com, would maintain advertising client directories and customized background advertisement serving software corresponding to web page owners. As the various software programs are accessed, they serve through defined pools of advertisements for each web page owner and/or web page, tracking and billing accordingly. Money or other valuable consideration is generally exchanged from advertised entities by brokerage and/or by web page owners for exposing advertisements, either before or after advertisement exposures, based on exact or estimated exposures. In some implementations, value may not exchange hands between the same or affiliated entities. In other implementations, as would be understood by those reasonably skilled in the art of the present invention, “cookies” or other files accessible on the workstation 11 can be utilized to record which advertisements have been viewed by a particular user to assist in distributing more distinct advertisements to each user, in which case the advertisement software serving software would manage and use such information.

Referring back to FIG. 4, after web page coding with the background advertising reference is received by the browser client 52 (step 308), the browser client 52 begins displaying web page coding (step 310). At this point, foreground text (such as “Company A Web Page”) begins showing on the browser client 52. Of course, references herein to displaying material on the browser client 52 or browser client window correspond to a browser client portion of the software controlled display 50 (FIG. 2), as would be understood by those reasonably skilled in the art of the present invention. In other implementations, step 310 is delayed until after steps 312-320. As the browser client 52 begins attempting to interpret the web page coding, the body tag with the background advertisement reference prompts the browser client 52 to transmit a request for the background advertisement (step 312). Subsequently, a web server, such as the web server 152 (or another web server remotely located from the web server 152, depending on the address of the background advertisement reference) receives the request (step 314) and transmits a background advertisement to the browser client 52 (step 316), after which the browser client 52 receives the background advertisement (step 318) and displays the background advertisement (step 320). Of course, as discussed above, the request may include a reference to a particular advertisement file or an advertisement serving software program.

In concluding the detailed description, it should be noted that it will be obvious to those skilled in the art that many variations and modifications can be made to the preferred embodiment without substantially departing from the principles of the present invention. All such variations and modifications are intended to be included herein within the scope of the present invention, as set forth in the following claims.

We claim:

1. A web page background advertising method comprising steps of:
initiating generation of web page coding responsive to receiving a web page request from a user;
inserting into the web page coding a background reference to an advertisement, wherein the background reference includes a tiling background attribute of a hypertext markup language (HTML) body tag; and
receiving value in exchange for inserting the background reference.

2. The method of claim 1, wherein the background attribute is set to a uniform resource locator (URL) identifying a bitmap file stored on a server accessible through the Internet.

3. The method of claim 1, wherein the background attribute is set to a uniform resource locator (URL) identifying a background advertisement serving software program configured to serve through a plurality of advertisements.

4. The method of claim 3, wherein the URL includes a web page owner identification reference.

5. The method of claim 3, wherein the URL includes a web page identification reference.

6. The method of claim 1, wherein said initiating step includes initiating generation of static web page coding, and further comprising a step of saving the static web page coding in an Internet accessible location.

7. The method of claim 1, wherein said initiating step includes transmitting an initial portion of dynamically created web page coding from a server to a client, wherein said inserting step includes transmitting the background reference from the server to the client.

8. The method of claim 1, wherein the exchange of value includes exchange of monetary value in return for advertisement exposure.

9. The method of claim 1, wherein said web page coding is owned by a first entity, and wherein said advertisement advertises for an entity other than said first entity.

10. The method of claim 1, wherein said web page coding is primarily associated with a first entity, and wherein said advertisement advertises for an entity other than said first entity.

11. A web page background advertising method comprising steps of:
storing a plurality of background advertisements;
receiving a request for a background advertisement; and
transmitting a background advertisement in response to receiving the request for a background advertisement.

12. The method of claim 11, wherein said receiving step includes receiving a request from a browser client.

13. The method of claim 12, further comprising a step of selecting a background advertisement from said plurality of stored background advertisements based upon information received in said request.

14. The method of claim 13, wherein said information includes a web page owner identification reference.

15. The method of claim 13, wherein said information includes a web page identification reference.

16. The method of claim 11, further comprising steps of tracking background advertisement exposures and billing advertised entities based upon tracked exposures.
